(19) United States
(12) Patent Application Publication
(10) Pub. No.: US 2026/0084508 A1
(43) Pub. Date: Mar. 26, 2026

(54) Energy Store Floor System for an Electrically Drivable Motor Vehicle

(71) Applicant: Bayerische Motoren Werke Aktiengesellschaft, Muenchen (DE)

(72) Inventor: Christoph AMANN, Muenchen (DE)

(21) Appl. No.: 19/113,470

(22) PCT Filed: Sep. 15, 2023
(86) PCT No.: PCT/EP2023/075485

§ 371 Date: Mar. 20, 2025

(30) Foreign Application Priority Data
Oct. 12, 2022 (DE) 10 2022 126 585.4

(51) Int. Cl. B60K 1/04; B62D 25/20

(52) U.S. Cl. CPC B60K 1/04; B62D 25/2018; B60K 2001/0438; B60Y 2306/01

(57) ABSTRACT

An energy store floor system for an electrically drivable motor vehicle, with a storage housing which is arranged below a vehicle floor, has a connection panel and, at a front end, borders a front section of the motor vehicle. In order to achieve an energy store floor system with an energy store which is particularly advantageously protected in the event of a head-on collision of the motor vehicle, a protection element for avoiding excessive accident-induced intrusions is arranged at the front end on the outer side of the storage housing of the energy store.

### BACKGROUND AND SUMMARY

The invention relates to an energy-storage floor layout for an electrically powered motor vehicle.

An energy-storage floor layout of such a type-already known from DE 10 2021 101 730 A1, for instance—includes a storage housing, arranged beneath the floor of the vehicle and exhibiting a terminal board, of an underfloor energy-storage unit. In the region of a center tunnel of the vehicle floor, the storage housing exhibits a raised portion, or a two-story configuration of respective battery cells or battery modules, which with its front end borders an anterior body section of the motor vehicle, in the region of which respective components of the anterior body section, for instance, are arranged.

However, components of such a type present the problem that they may be displaced rearward due to an accident, for instance in the event of a frontal collision with an obstacle, for instance with a rigid barrier or with a party to the accident, with a pole impact or, where appropriate, also with an offset barrier, as a result of which the front end of the storage housing may be damaged, in particular in the region of the center tunnel. In the worst case, a thermal event may arise as a result of this.

For this reason, in the case of the energy-storage floor layout according to the prior art, a structural element acting in the manner of a tension rod has been provided, which is fastened by its ends to the longitudinal member, or engine mounting, of the anterior body section assigned laterally in the given case.

The object of the present invention is to provide an energy-storage floor layout in which the energy-storage unit is protected particularly favorably against excessive intrusion in the case of a rearward relocation of a component due to an accident.

In accordance with the invention, this object is achieved by an energy-storage floor layout with the features of the independent claim(s). Advantageous developments are the subject of the dependent claims.

The energy-storage floor layout according to the invention for a motor vehicle equipped with an electric drive includes a storage housing, arranged beneath a vehicle floor and having a terminal board, which with a front end borders an anterior (front) body section of the motor vehicle.

In order to obtain an energy-storage floor layout with an energy-storage unit that is protected particularly favorably in the event of a frontal collision of the motor vehicle, in accordance with the invention there is provision that a protective element is arranged on the storage housing at the front end on the outside of the storage housing of the energy-storage unit, by means of which an excessive intrusion, for instance of a component or the like of the anterior body section, into the storage housing of the energy-storage unit due to an accident can be averted. By virtue of the external arrangement of the protective element on the storage housing of the energy-storage unit, in addition a particularly favorable potential for preassembly arises, so that the protective element can be preassembled appropriately on the storage housing prior to the fastening/welding of the storage housing to the vehicle body. By this means, a particularly favorable preassembled mounting of the storage housing and the protective element arises overall.

In further refinement of the invention, the front end of the storage housing of the energy-storage unit and the protective element protrude forward in the longitudinal direction of the vehicle in relation to the vehicle floor in the direction of the anterior body section. Such a projection is required, for instance, if a terminal board of the energy-storage unit is necessary for coupling various leads, cables or the like. By virtue of the protective element, the front end of the storage housing, for instance, is consequently protected particularly favorably against excessive damage as a consequence of a frontal collision, and against associated intrusions into the storage housing.

Furthermore, it has proved to be advantageous if the protective element is arranged in a middle region of the storage housing of the energy-storage unit with reference to the transverse direction of the vehicle. Considerable intrusions may occur precisely in this central middle region of the storage housing, for instance in the event of a rearward displacement of corresponding components or assemblies due to an accident.

In this context, it has proved to be further advantageous if in the region of a center tunnel of the vehicle floor the energy-storage unit exhibits a raised portion which is covered by the protective element. Consequently the free construction space within the center tunnel can be optimally utilized by the energy-storage unit, for instance for the purpose of forming a two-story energy-storage unit, in which case the energy-storage unit can be optimally protected by the protective element which is arranged in a middle region of the storage unit with reference to the transverse direction of the vehicle.

Another advantageous embodiment of the invention provides that the protective element is constituted by an external metal part, in particular a sheet-metal formed part, and by an energy-absorbing plastic part arranged on the inside of the metal part. The double-shell structure with a metallic outer skin and with an appropriate synthetic material—for instance, a rigid foam-on the inside, makes it possible that, on the one hand, the storage housing, or the energy-storage unit, is protected against penetrating components and, on the other hand, the load can be optimally distributed, and consequently deformations can be reduced.

The external metal part and the energy-absorbing plastic part arranged on the inside of the metal part have, in particular, been produced separately from one another and have been connected to one another by means of appropriate connecting elements. As an alternative to this, a jointing connection is of course also possible. Similarly, it would of course alternatively also be contemplated to attach an appropriate plastic part to the external metal part by injection molding or to attach such a part to the metallic outer part by primary forming.

Another advantageous embodiment of the invention provides that the protective element covers the terminal board of the energy-storage unit. Precisely the terminal board of the energy-storage unit has proved to be a particularly sensitive point which has to be protected particularly securely against damage as a consequence of applications of force caused by an accident.

Another advantageous embodiment of the invention provides that the protective element is connected to the storage housing of the energy-storage unit in force-closed and/or form-closed manner. A form-closed connection, or a form of the protective element that has been matched to the shape of the storage housing, has the advantage that an extensive support of the protective element on the storage housing can be realized. By this means, excessive intrusions into the storage housing are averted particularly favorably. The force-closed connection enables an appropriately stable linkage of the protective element to the storage housing.

Another advantageous embodiment of the invention provides that the storage housing is constituted by an upper part and a lower part which are connected to one another in the region of a separation plane, the protective element merely being arranged on and fastened to the lower part. By this means, a particularly favorable fixing of the protective element to the lower part arises, the protective element overlapping the upper part, in particular in the region of the raised portion, and consequently also providing for an appropriate protection of the upper part in the region of the overlap.

Lastly, it has proved to be advantageous if the protective element is arranged in the region of a recess of respective energy-absorbing profiles at the front end of the storage housing of the energy-storage unit. The energy-absorbing profiles can serve for further absorption of impact energy in the case of a frontal collision, in which case the protective element arranged in the region of the recess ensures the appropriate protection of the storage housing, or of the energy-storage unit, against excessive intrusions.

Further features of the invention can be gathered from the claims, from the figures and from the description of the figures. The features and combinations of features mentioned above in the description, and also the features and combinations of features mentioned below in the description of the figures and/or shown in the figures alone, are capable of being used not only in the respectively specified combination but also in other combinations or on their own.

The invention will now be elucidated in more detail on the basis of a preferred embodiment example and with reference to the drawings.

### BRIEF DESCRIPTION OF THE DRAWINGS

FIG. 1 is a partial plan view of an energy-storage floor layout according to an embodiment of the invention for an electrically powered motor vehicle, with a storage housing, arranged beneath a vehicle floor, of an energy-storage unit and also with an anterior body section of the motor vehicle, which the vehicle floor, or the storage housing, borders with a front end, wherein at the front end on the outside of the storage housing of the energy-storage unit in the region of a center tunnel of the vehicle floor a protective element is arranged on the storage housing, by which in the event of a frontal collision of the motor vehicle excessive intrusions into the storage housing caused by the accident can be averted.

FIG. 2 is a partial perspective view, obliquely from the front, of the storage housing of the energy-storage unit of the energy-storage floor layout in the central front region of which the protective element is arranged in form-closed and force-closed manner.

FIG. 3 is a perspective view, obliquely from the rear outside, of the protective element according to FIG. 2, which is constituted by an external metal part and an energy-absorbing plastic part arranged on the inside of the metal part.

FIG. 4 is respective partial plan views of the energy-storage floor layout before and after a frontal collision with a pole.

FIG. 5 is a partial perspective side view along a sectional plane extending in the vertical direction of the vehicle and in the longitudinal direction of the vehicle through the energy-storage floor layout according to the invention after a pole impact, analogous to the lower illustration in FIG. 4.

FIG. 6 is respective partial plan views of the energy-storage floor layout according to the invention before and after a frontal collision of the motor vehicle with an obstacle with slight width overlap.

FIG. 7 is a partial perspective plan view of the protective element of the energy-storage floor layout after an application of force caused by an accident as a consequence of a frontal collision of the passenger car with an obstacle with slight width overlap according to FIG. 6.

### DETAILED DESCRIPTION OF THE DRAWINGS

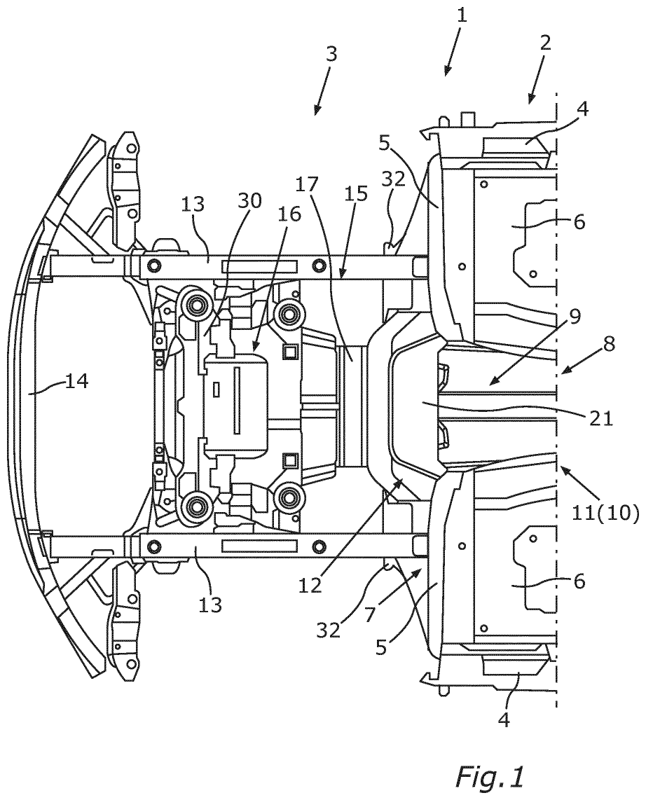

FIG. 1 shows, in a partial plan view of a passenger car, a motor-vehicle body 1 which includes a vehicle floor 2 at the bottom of a passenger cell, which merges with an anterior (front) body section 3 at its front end. In particular, respective front ends of side sills 4 of the vehicle floor 2 are discernible, between which at the front end of the vehicle floor 2 there extends a front lower crossmember 5, as far as which respective floor parts 6—for instance, floor panels—of the vehicle floor 2 extend forward in the longitudinal direction of the vehicle. A front bulkhead 7 which bounds the passenger cell toward the front, or which partitions the passenger cell from the anterior body section 3, extends in the region above the crossmember 5.

A center tunnel 8 of the vehicle floor 2 is further discernible which extends rearward in the longitudinal direction of the vehicle in a central centric region of the vehicle floor. In the case of a vehicle variant with an internal-combustion engine (ICE), this center tunnel 8 is ordinarily utilized to accommodate a drive shaft for connecting the internal-combustion engine arranged in the region of the anterior body section to a rear-axle transmission for a driven rear axle of the vehicle.

In the present case, in which a motor vehicle with a purely electric drive (BEV) or, where appropriate, alternatively with a hybrid drive (PHEV) is shown, the center tunnel serves for receiving a raised portion 9 of an energy-storage unit (energy store) 10 (which is shown in more detail in the following), the storage housing 11 of which is arranged beneath the vehicle floor 2—that is to say, beneath the respective floor parts 6 and at least substantially between the respective side sills 4 and to the rear of the crossmember 5.

From FIG. 1 it can, in addition, be discerned that the front end 12 of the storage housing 11 of the energy-storage unit 10, or, in particular, of the raised portion 9, on the one hand protrudes in the direction of the anterior body section 3 in the longitudinal direction of the vehicle in relation to the vehicle floor 2 and in relation to the crossmember 5 terminating the vehicle floor 2 toward the front, and on the other hand borders the anterior body section 3 with this front end 12.

Respective main longitudinal members 13 of the anterior body section 3 are firstly discernible which extend parallel to one another in the longitudinal direction of the vehicle at the level of a plane of the main longitudinal members. These main longitudinal members 13 are also designated as longitudinal members of the engine. The main longitudinal members 13 adjoin the passenger cell and the vehicle floor 2 toward the rear in the region of the front bulkhead 7 and of the crossmember 5, and, with respective longitudinal-member parts, merge, on the one hand, with the side sills 4 and, on the other hand, with respective members in the region of the center tunnel 8. At the front end, a fender crossmember 14 is supported on the main longitudinal members 13 via respective energy-absorbing elements.

A front-axle member 15 or the like is fastened on the underside of the main longitudinal members 13 to a subframe on which, on the one hand, respective chassis elements of the front axle are fastened and, on the other hand, respective assemblies, components, or the like are loaded. In the present embodiment example, an electrical refrigerant compressor 16 is loaded on the front-axle member 15 by means of a holding device 30 at a distance in front of the front end 12 of the raised portion 9, or of the storage housing 11, which with reference to the vertical direction of the vehicle and the transverse direction of the vehicle is accordingly arranged in overlap with the front end 12 of the storage housing 11 in the region of the center tunnel 8, or of the raised portion 9. Likewise, in the neighborhood in front of the front end 12 of the storage housing 11 and in the region of the raised portion 9, a crossmember 17 of the front-axle member 15 extends which is fastened to the underside of the respective main longitudinal members 13.

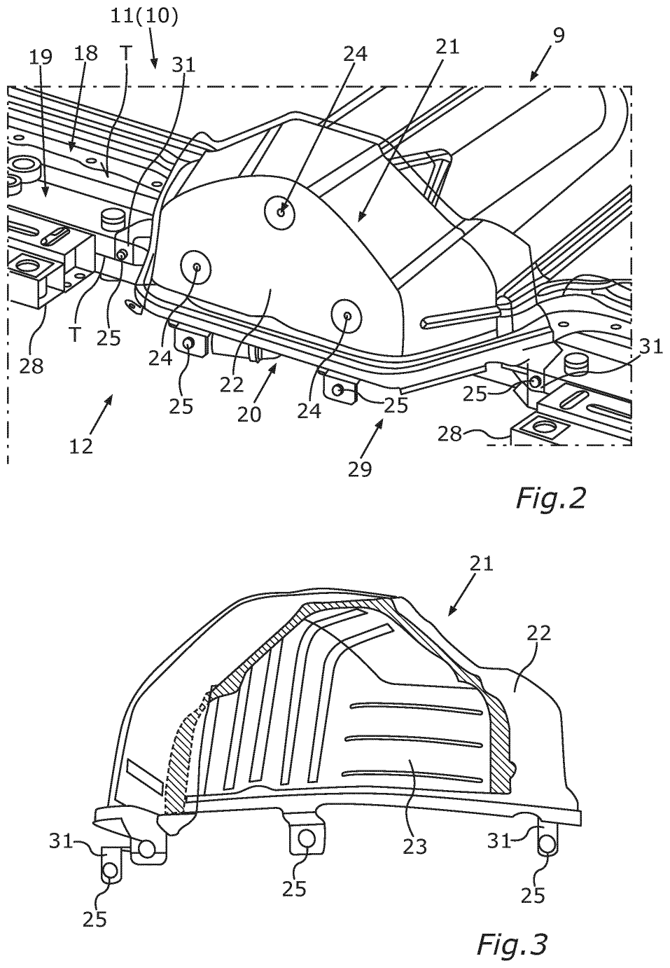

FIG. 2 shows, in a partial perspective view obliquely from the front above, the front end 12 of the storage housing 11, arranged beneath the vehicle floor, of the energy-storage unit 10. The storage housing 11 comprises an upper part 18 and a lower part 19 which are partitioned from one another, or connected to one another, in the region of a separation plane T extending horizontally in the transverse direction of the vehicle and in the longitudinal direction of the vehicle.

Likewise discernible from FIG. 2 is the raised portion 9 with which the storage housing 11 of the energy-storage unit 10 protrudes into the center tunnel 8 of the vehicle floor 2 in the manner described. In the region of this raised portion 9, the energy-storage unit 10 has been formed in two levels—that is to say, battery cells or battery modules are arranged appropriately one above the other in two layers with reference to the vertical direction of the vehicle. The raised portion 9 extends as far as the front end 12 of the storage housing 11 and thereby borders, in the manner described, the anterior body section 3 or associated assemblies, for instance the electrical refrigerant compressor 16.

In addition, a terminal board 20 of the energy-storage unit 10 is provided at the front end of the raised portion 9 on the lower part 19 of the storage housing 11, via which the energy-storage unit 10 is connected to, for instance, electrical leads or media lines—for instance, coolant lines. In addition, appropriate power-electronics components may have been accommodated in the region of the terminal board 20. The terminal board 20 extends substantially at the level of the separation plane T.

For reasons of protection, explained in more detail in the following, both the terminal board 20 and the front end 12 of the storage housing 11 of the energy-storage unit 10 are arranged concealed behind a protective element 21 which is represented in FIG. 3 in a separate perspective view obliquely from the rear.

In the present case, the protective element 21 is arranged in the region of a recess 29 of respective energy-absorbing profiles 28 at the front end of the lower part 18 of the storage housing 11 of the energy-storage unit 10. The energy-absorbing profiles 28 serve for further absorption of impact energy in the case of a frontal collision, in which case the protective element 21 arranged in the region of the recess 29 ensures the appropriate protection of the storage housing 11, or of the energy-storage unit 10, against excessive intrusions.

In the present case, this protective element 21 has been formed at least substantially in two parts with an external metal part 22 which in the present case takes the form of a sheet-metal formed part. Of course, other configurations consisting of metal or, where appropriate, alternatively of a synthetic material, in particular a fiber-reinforced synthetic material, would also be usable here. On the inside of this metal part 22—that is to say, on the side of the metal part 22 facing toward the storage housing 11 of the energy-storage unit 10—an energy-absorbing plastic part 23 is arranged which has been formed, for instance, from a rigid foam of synthetic material. Of course, other configurations of this absorbing part would also be usable here.

In the present case, the two structural parts of the protective element or of the protective cap 21—that is to say, the metal part 22 and the plastic part 23—have been configured separately and have been connected to one another, for instance by means of connecting elements 24 discernible in FIG. 2. As an alternative to this, it would also be contemplated for the plastic part 23 to be, for instance, attached to the metal part 22 by injection molding. In addition, in the present case it is worth mentioning that the plastic part 23 has been matched in its outer shape to the inner shape of the metal part 22.

In particular from FIG. 2 it can, in addition, be discerned that in the present case the protective element 21 has been at least substantially matched in form-closed manner to the shape of the terminal board 20, or to the shape of the raised portion 9 of the storage housing 11. In this connection, it is to be understood by the term “form closure” that the protective element 21 has been matched to the storage housing 11, or to the terminal board 20, in such a way that it is appropriately supported toward the rear in the longitudinal direction of the vehicle, or is supported on the storage housing 11 in the transverse direction of the vehicle and in the vertical direction of the vehicle (from the top to the bottom). In addition, the protective element 21 is connected to the storage housing 11 in force-closed manner via respective screw elements 25 by means of angle elements 31. In particular, the outer angle elements 31 are likewise connected to the lower part 19 in force-closed and form-closed manner, so that a particularly favorable mounting of the protective element 21 arises in the event of an application of force caused by an accident. In the present case, the protective element 21 is merely connected to the lower part 19 of the storage housing 11, the protective element 21 extending substantially above the separation plane T between the upper part 18 and the lower part 19 of the storage housing 11.

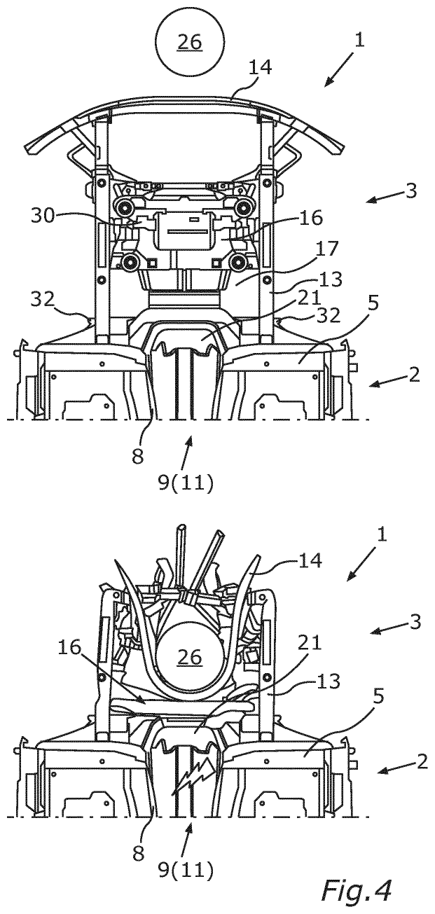

The concrete function of the protective element 21 will now be explained in the following on the basis of FIGS. 4 to 7.

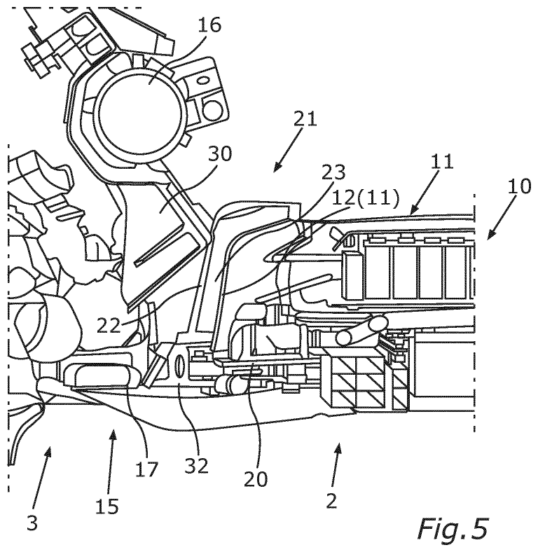

FIG. 4 shows respective partial plan views of the body of the motor vehicle in the region of the anterior body section 3 and the transition to the vehicle floor 2 beneath which the storage housing 11 of the energy-storage unit 10 is arranged, this housing being discernible, in particular, in the region of the center tunnel 8 with the raised portion 9. The upper representation in FIG. 4 shows the motor vehicle prior to a collision with a pole 26 which, according to the lower representation in FIG. 4, has penetrated into the motor vehicle approximately in the middle of the anterior body section 3 after a central collision of the motor vehicle. As a consequence of the frontal collision, or of the pole impact, due to the accident a rearward displacement occurs, for instance of the electrical refrigerant compressor 16 which, as a result, impinges on the protective element 21, as is shown in FIG. 5 in a partial and perspective sectional view along a sectional plane extending in the vertical direction of the vehicle and in the transverse direction of the vehicle in the region of the middle of the vehicle.

By consideration of the lower representation in FIG. 4 together with, in particular, FIG. 5, it can be discerned that the protective element 21 ensures that in the region of the end 12 protruding forward in the longitudinal direction of the vehicle in relation to the crossmember 5, or in relation to the vehicle floor 2, or in the region of the raised portion 9 of the storage housing 11, considerable intrusions cannot result that, for instance, may cause a thermal event or excessive damage to the terminal board 20 of the energy-storage unit 10. Rather, in particular by virtue of the double-shell structure of the protective element 21 consisting of the metal part 22 and the plastic part 23 it is ensured that, on the one hand, protection is afforded against an excessive penetration of components—in the present case, the refrigerant compressor 16—and, on the other hand, the load and consequently the deformation is reduced. By virtue of the form-closed support and also the force-closed linkage of the protective element 21, this protection against the penetration of components, or the load-distributing function of the protective element 21, is additionally improved.

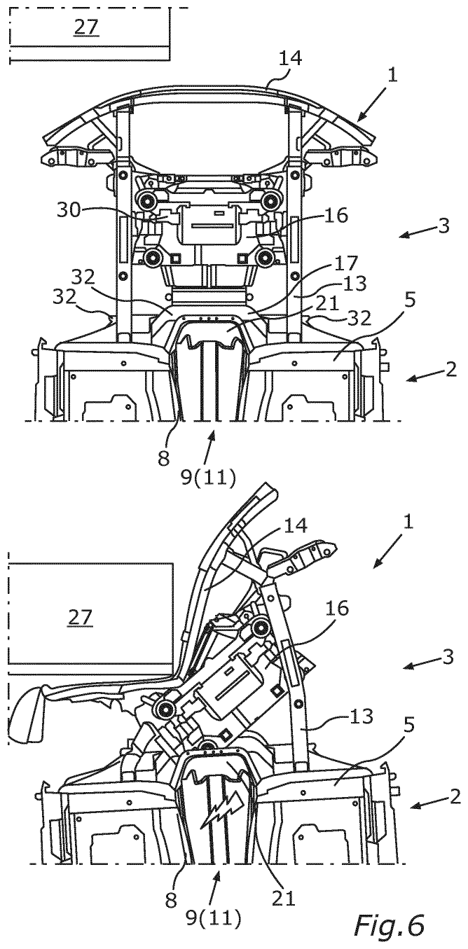

FIG. 6 shows, in an illustration analogous to FIG. 4, two partial plan views of the motor vehicle in the region of the anterior body section 3, or in the transition to the vehicle floor 2 prior to and after, respectively, a frontal collision with an obstacle 27 with slight width overlap (offset crash).

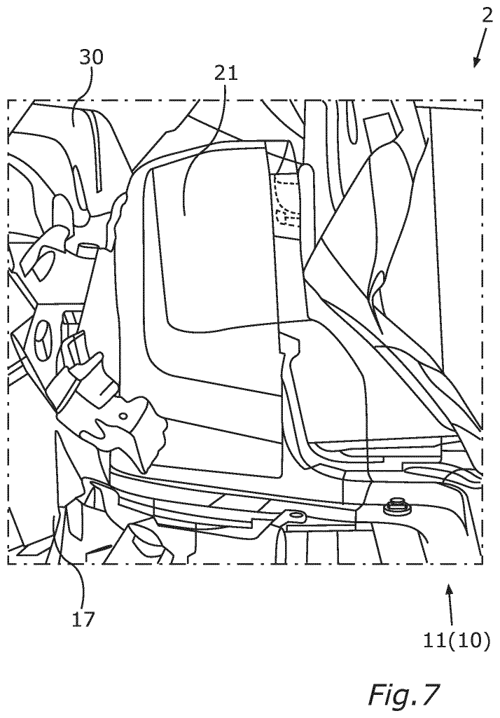

By consideration of this figure together with FIG. 7, which shows a partial and perspective plan view of the motor vehicle in the region of the protective element 21 after the frontal collision, it becomes evident that also in the event of the occurrence of such an accident the protective element 21 ensures that excessive deformations of the storage housing 11 of the energy-storage unit 10 in the region of the center tunnel 8, or of the raised portion 9, which, for instance, are caused by the rearward displacement of the refrigerant compressor 16 or of the crossmember 17 of the front-axle member 15 due to an accident, are averted and, moreover, the load introduced as a consequence of the impact of this component, or of this crossmember, is distributed, and consequently deformations are likewise reduced. Also discernible in FIG. 7 is a short adapter piece 32 for connecting the front axle member to the storage housing 11 of the energy-storage unit 10.

List of Reference Symbols

| | |
|---|---|
| 1 | motor-vehicle body |
| 2 | vehicle floor |
| 3 | anterior (front) body section |
| 4 | side sill |
| 5 | crossmember |
| 6 | floor parts |
| 7 | front bulkhead |
| 8 | center tunnel |
| 9 | raised portion |
| 10 | energy-storage unit (energy store) |
| 11 | storage housing |
| 12 | front end |
| 13 | main longitudinal member |
| 14 | crossmember |
| 15 | front-axle member |
| 16 | refrigerant compressor |
| 17 | crossmember |
| 18 | upper part |
| 19 | lower part |
| 20 | terminal board |
| 21 | protective element |
| 22 | metal part |
| 23 | plastic part |
| 24 | connecting elements |
| 25 | screw elements |
| 26 | pole |
| 27 | obstacle |
| 28 | energy-absorbing elements |
| 29 | recess |
| 30 | holding device |
| 31 | angle element |
| 32 | adapter piece |
| T | separation plane |

1.-10. (canceled)

11. An energy-storage floor layout for an electrically powered motor vehicle, comprising:
a storage housing of an energy store which is arranged beneath a vehicle floor, the storage housing having a terminal board and, at a front end, bordering an anterior body section of the motor vehicle; and
a protective element arranged at the front end on an exterior of the storage housing of the energy store, the protective element being configured to avoid excessive intrusions caused by an accident.

12. The energy-storage floor layout according to claim 11, wherein
the front end of the storage housing of the energy store and the protective element protrude forward in a longitudinal direction of the vehicle in relation to the vehicle floor in a direction toward the anterior body section.

13. The energy-storage floor layout according to claim 11, wherein
the protective element is arranged in a middle region of the storage housing of the energy store with reference to a transverse direction of the vehicle.

14. The energy-storage floor layout according to claim 13, wherein
in a region of a center tunnel of the vehicle floor, the energy store has a raised portion which is covered by the protective element.

15. The energy-storage floor layout according to claim 11, wherein
the protective element is constituted by an external metal part and an energy-absorbing plastic part arranged on an inside of the metal part.

16. The energy-storage floor layout according to claim 15, wherein the external metal part is a sheet-metal formed part.

17. The energy-storage floor layout according to claim 15, wherein
the external metal part and the energy-absorbing plastic part arranged on the inside of the metal part are produced separately and are connected to one another via connecting elements.

18. The energy-storage floor layout according to claim 11, wherein
the terminal board of the energy store is covered by the protective element.

19. The energy-storage floor layout according to claim 11, wherein
the protective element is connected to the storage housing of the energy store in force-closed and/or form-closed manner.

20. The energy-storage floor layout according to claim 11, wherein
the storage housing is constituted by an upper part and a lower part which are connected to one another in a region of a separation plane, and
the protective element is only connected to the lower part.

21. The energy-storage floor layout according to claim 11, wherein
the protective element is arranged in a region of a recess of respective energy-absorbing profiles at the front end of the storage housing of the energy store.
